(19) United States
(12) Patent Application Publication
(10) Pub. No.: US 2018/0260815 A1
(43) Pub. Date: Sep. 13, 2018

(54) INTERNET OF THINGS RECOGNITION OF QUESTIONABLE ACTIVITY

(71) Applicant: International Business Machines Corporation, Armonk, NY (US)

(72) Inventors: Michael BENDER, Rye Brook, NY (US); Rhonda L. CHILDRESS, Austin, TX (US)

(21) Appl. No.: 15/454,659

(22) Filed: Mar. 9, 2017

(51) Int. Cl. G06Q 20/40; G06Q 20/32

(52) U.S. Cl. CPC G06Q 20/4016; G06Q 20/3224

(57) ABSTRACT

A method, computer program product, and system includes a processor(s) receiving user identification data, identification data related to personal computing devices, and credential information for accessing data collected by the one or more personal computing devices. The processor(s) obtains an indication of program(s) initiating a transaction initiated on behalf of the user. The processor(s) utilize the credential information to access data related to the user collected by the personal computing devices contemporaneously with the initiating the transaction. The processor(s) determines a risk of fraud associated with the transaction, based on a portion of the data related to the user, where the risk of fraud indicates a likelihood that the transaction is fraudulent. The processor(s) alert the program(s) initiating the transaction of the risk of fraud.

### BACKGROUND

The Internet of Things (IoT) is a system of interrelated computing devices, mechanical and digital machines, objects, animals and/or people that are provided with unique identifiers and the ability to transfer data over a network, without requiring human-to-human or human-to-computer interaction. These communications are enabled by smart sensors, which include, but are not limited to, both active and passive radio-frequency identification (RFID) tags, which utilize electromagnetic fields to identify automatically and to track tags attached to objects and/or associated with objects and people. Smart sensors, such as RFID tags, can track environmental factors related to an object, including but not limited to, temperature and humidity. The smart sensors can be utilized to measure temperature, humidity, vibrations, motion, light, pressure and/or altitude. Because the smart sensors carry unique identifiers, a computing system that communicates with a given sensor can identify the source of the information. Within the IoT, various devices can communicate with each other and can access data from sources available over various communication networks, including the Internet.

### SUMMARY

Shortcomings of the prior art are overcome and additional advantages are provided through the provision of a method for determining a risk of a transaction being fraudulent. The method includes, for instance: receiving, by one or more processors, into a data repository, over a communications connection, user identification data, identification data related to one or more personal computing devices, and credential information for accessing data collected by the one or more personal computing devices; obtaining, by the one or more processors, an indication that one or more programs are initiating a transaction, wherein transaction data of the transaction indicates that the transaction was initiated on behalf of the user; utilizing, by the one or more processors, the credential information to access data related to the user collected by the one or more personal computing devices, wherein the data related to the user was collected by the one or more personal computing devices contemporaneously with the initiating the transaction; determining, by the one or more processors, a risk of fraud associated with the transaction, based on a portion of the data related to the user, wherein the risk of fraud indicates a likelihood that the transaction is fraudulent; and alerting, by the one or more processors, the one or more programs initiating the transaction of the risk of fraud.

Shortcomings of the prior art are overcome and additional advantages are provided through the provision of a computer program product for determining a risk of a transaction being fraudulent. The computer program product comprises a storage medium readable by a processing circuit and storing instructions for execution by the processing circuit for performing a method. The method includes, for instance: receiving, by one or more processors, into a data repository, over a communications connection, user identification data, identification data related to one or more personal computing devices, and credential information for accessing data collected by the one or more personal computing devices; obtaining, by the one or more processors, an indication that one or more programs are initiating a transaction, wherein transaction data of the transaction indicates that the transaction was initiated on behalf of the user; utilizing, by the one or more processors, the credential information to access data related to the user collected by the one or more personal computing devices, wherein the data related to the user was collected by the one or more personal computing devices contemporaneously with the initiating the transaction; determining, by the one or more processors, a risk of fraud associated with the transaction, based on a portion of the data related to the user, wherein the risk of fraud indicates a likelihood that the transaction is fraudulent; and alerting, by the one or more processors, the one or more programs initiating the transaction of the risk of fraud.

Methods and systems relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a workflow illustrating certain aspects of an embodiment of the present invention;

FIG. 2 is a workflow illustrating certain aspects of an embodiment of the present invention;

FIG. 3 is a workflow illustrating certain aspects of an embodiment of the present invention;

FIG. 4 depicts one embodiment of a computing node that can be utilized in a cloud computing environment;

FIG. 5 depicts a cloud computing environment according to an embodiment of the present invention; and

FIG. 6 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

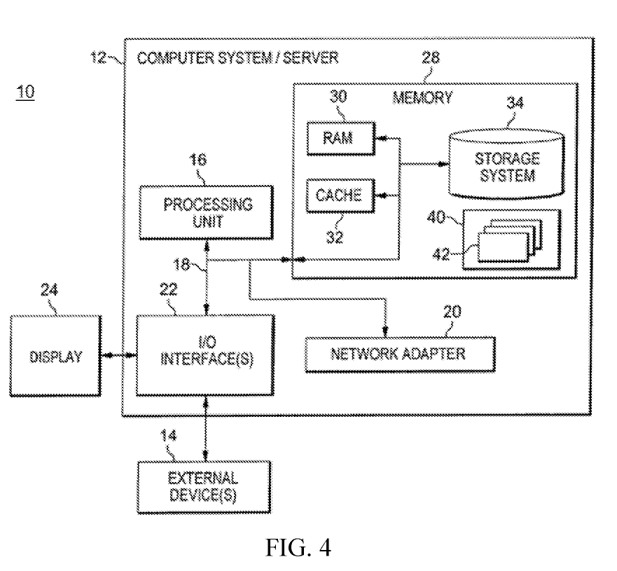

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 4 as program/utility 40, having a set (at least one) of program modules 42, may be stored in memory 28.

IoT devices refer to computing devices that form the IoT (as aforementioned, the Internet of Things), which is a system of interrelated computing devices, mechanical and digital machines, objects, animals and/or people that are provided with unique identifiers and the ability to transfer data over a network, without requiring human-to-human or human-to-computer interaction. Embodiments of the present invention include a computer-implemented method, a computer program product, and a computer system that utilize multiple IoT devices, and their interconnectivity to each other, to mitigate the risk of fraudulent transactions of the Internet or any other computer network, whether public, private, or hybrid. As will be explained herein, these embodiments mitigate transaction fraud, in part, by determining the veracity of a transaction based on real time data not part of the transaction.

Embodiments of the present invention verify a transaction based, at least in part, on real time location data, related to the location of the individual attempting the transaction. In fact, one advantage of certain embodiments of the present invention is that they include one or more programs that determine the likelihood that a given transaction conducted from a computing device, including an IoT device, utilized by an individual, is fraudulent, based on determining the location of the individual as related to the details of the transaction. While some existing fraud prevention systems may utilize a general location of an individual (e.g., street address, city, country), but the limiting of activities that you could do at a specific location, embodiments of the present invention flag suspicious activity based on a more granular location and an understanding of what activities are possible at that granular location. In embodiments of the present invention, one or more programs utilize data from various IoT devices to determine whether a given transaction (or activity) is fraudulent, when executed from a given location. For example, based on an IoT device proximate and/or worn by a guest at a hotel, one or more programs in an embodiment of the present invention determine that the individual is in the pool area of the hotel. When the individual attempts an electronic transaction, one or more programs analyze the transaction to determine the likelihood that the transaction is fraudulent based on the nature of the transaction and the location of the individual. In this case, the one or more programs may determine that a transaction where the individual attempts to purchase refreshments (given that there is a restaurant at the pool) is likely not fraudulent, but meanwhile, the one or more programs may determine that an attempted purchase at a store proximate to the hotel is likely fraudulent because the individual cannot be both at the pool and at this store, simultaneously.

The understanding of a granular location that is utilized by the program code in embodiments of the present invention to determine whether a transaction is fraudulent differs greatly from the concept of location as a fraud indicator, as applied in existing systems. For example, some existing fraud detection systems may see that a user is attempting a transaction from Miami Beach and compare that location to the user's home address in St. Louis, to determine that the transaction may be fraudulent. In this same system, provided that the system knows, from the travel history of the user, that the user vacations in Miami Beach, the program may be less likely to flag the transaction is fraudulent. Meanwhile, in embodiments of the present invention, while the program code can utilize the location, home address and travel habits of the user, the program code also flag transaction based on the type of activities that the user can partake in at a given time. For example, if a user makes a purchase at a boutique in Miami Beach, but the one or more programs determine, based on a personal fitness device worn by the user, that this purchase is contemporaneous with the user swimming in the ocean, the one or more programs may flag the transaction as fraudulent. Meanwhile, the existing system mentioned earlier would not have noticed this discrepancy because the user is, in fact, in Miami Beach and the purchase is being made in Miami Beach.

Embodiments of the present invention verify a transaction based, at least in part, on real time physical state data, related to the physical state of the individual attempting the transaction. Some embodiments of the present invention provide advantages over existing fraud detection systems based on one or more programs in the embodiments determining whether a transaction is likely fraudulent, based on the state of the user allegedly engaging in the transaction. The one or more programs determine the state of the user based on IoT devices worn by and/or proximate to the user. For example, in an embodiment of the present invention, one or more programs identify that a given user has initiated a transaction. However, one or more IoT devices worn by or proximate to the user indicate that the user is sleeping, for example, based on biometric data. Based on determining the state of the user, the one or more programs determine that this transaction is likely fraudulent.

Embodiments of the present invention also present advantages over existing fraud alert systems because they are highly customizable. For example, in some embodiments of the present invention, one or more programs, based on obtaining user preferences through an input/output device, configure which IoT device, including but not limited to, sensors, will provide data to the one or more programs when these one or more programs evaluate whether an electronic assessment is valid or fraudulent. Thus, based on this customization, only data from certain sensors would be included in risk assessments conducted by the program code.

Embodiments of the present invention verify a transaction based, at least in part, on real time behavioral data, related to the behavioral patterns of the individual attempting the transaction. In certain embodiments of the present invention, the program code will utilize machine learning algorithms to learn the behavioral patterns of users, thus, enabling the program code to more easily and quickly ascertain that a given transaction is likely fraudulent based on its deviation from known patterns. This machine learned information will also assist one or more programs in embodiments of the present invention in determining the likelihood that a given transaction is fraudulent when information obtained by the program code of the invention from varying sources conflicts. In addition, our one or more programs in an embodiment of the present invention can learn when certain otherwise questionable activities are safe, based on an understanding of the user who partakes in the activities. For example, if the program code learns that a given user is prone to wearing a personal fitness device (i.e., an IoT device) during physical activities but does not carry a phone, when the user makes a purchase at an athletic facility and the software determined that although the personal fitness tracker is proximate to the site of the transaction but the user's phone (i.e., also an IoT device) is at a different location, the one or more programs will not determine that the transaction is fraudulent based on this discrepancy.

Embodiments of the present invention represent an improvement that is inextricably tied to computing at least because aspects of these embodiments provide effective and efficient fraud protections for electronic transactions. in order to provide this protection, embodiments of the present invention utilize data accessible based on loT devices. The issue of fraudulent transactions (which include ecominerce transactions) is unique to computing and the solutions presented by embodiments of the present invention are firmly rooted in this environment.

Embodiments of the present invention provide a computer-implemented method, system, and computer program product that include one or more programs, executed by at least one processor, for evaluating a transaction, and determining, based on data obtained from IoT devices proximate to the user attempting the transaction, whether to the transaction should be executed. In some embodiments of the present invention, the one or more programs may execute on the IoT device itself. In other embodiments of the present invention, the one or more programs execute on a device in communication with the IoT device. For illustrative purposes, aspects of embodiments of the present invention can be envisioned as a validation layer that operates as an intermediary between when a user initiates a transaction, for example, on an IoT device or a device in communication with one or more IoT devices and when the device executes the transaction.

As more transactions are generated by IoT devices or computing devices in communications with IoT devices, the possibility of fraudulent activity increases. Embodiments of the present invention address this issue by using data provided by multiple IoT devices to determine whether a transaction is within an acceptable level of risk, for a given user. If one or more programs in an embodiment of the present invention determine that a risk level is acceptable, the transaction completes. However, if the one or more programs determine that the transaction is not within this level (e.g., is an outlier), the one or more programs flag the transaction and may prevent the completion of the transaction on the device upon which the user initiated the transaction. In another embodiment of the present invention, the one or more programs do not automatically halt a transaction, but, rather, provide the user and/or a system into which this verification is integrated, an indication of a risk level of proceeding with the transaction, based on an analysis of the likelihood that the transaction is fraudulent.

Hence, in embodiments of the present invention, the one or more programs utilize a combination of factors, including real time data that is not related to a transaction itself (i.e., the data of the actual transaction), to determine a level of risk for fraud associated with a transaction. For example, in embodiments of the present invention, the one or more programs would flag (intercept, cancel, etc.) a transaction in circumstances that are not limited to the following: 1) a transaction is initiated on a user's cellular phone while the user's biometric data of the user's personal fitness tracker indicates that the user is running or exercising; 2) a transaction is initiated on a user's cellular phone while the user is driving a car that is in motion, as indicated by data from an IoT device on the steering wheel of the car, the global positioning system of the car, and the user's personal fitness tracker; 3) a transaction is initiated on a user's cellular phone while the user's personal fitness tracker's biometric data and GPS indicate that the user is swimming in an ocean; and 4) a credit card transaction is initiated at a mall, while the location services functionality on a user's cellular phone (an IoT device) indicates that the user is at a gas station.

Embodiments of the present invention may also classify the possibility of fraudulent activity as different risk levels. The activities in the last paragraph would likely be classified as presenting a high risk of fraud. Meanwhile, certain activities that would present a medium risk of fraud may include, but are not limited to: a transaction is initiated on a user's cellular phone while the user's personal fitness tracker's GPS indicates that the user is at a swimming pool (certain swimming pools have snack bars and people may transact business while lounging poolside). An example of an activity for which the one or more programs could indicate a low risk of fraud could be when a transaction is initiated on a user's personal mobile device while the user in in a restaurant. The latter activity could be classified as a low risk activity because it is not uncommon for individuals to engage in transactions while sitting at a table in a restaurant.

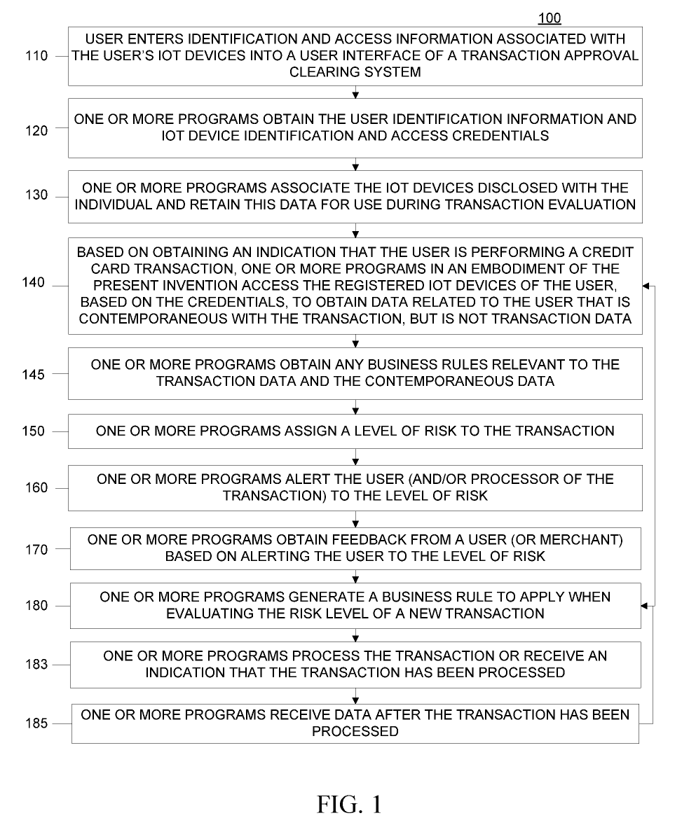

FIG. 1 is a workflow 100 that illustrates the registration of a user of IoT devices. As aforementioned, embodiments of the present invention can be understood as including one or more programs that form a validation layer, which identifies risks or risk levels associated with the veracity of transactions. The validation layer may be part of an electronic clearinghouse for transactions. In order to protect a given individual from transaction fraud, one or more programs, in an embodiment of the present invention, obtain data from various IoT devices associated with the individual. In order to identify these devices as being associated with the user, and to access data on the devices, the individual identifies the devices and provides one or more programs in an embodiment of the present invention with the credentials to access the devices.

Turning to FIG. 1, in certain embodiments of the present invention, based on registering IoT devices, one or more programs can utilize these devices in determining whether a given electronic (e.g., credit card) transaction traceable to the individual may include a risk of fraud. In an embodiment of the present invention, the user enters identification and access information associated with the user's IoT devices (e.g., cellular phone, personal fitness tracker, smart watch) into a user interface of a transaction approval clearing system (110). One or more programs in an embodiment of the preset invention obtain the user identification information and IoT device identification and access credentials (120). The one or more programs associate the IoT devices disclosed with the individual and retain this data for use during transaction evaluation (130). In some embodiments of the present invention, the user can provide the one or more programs with specific access to the IoT devices, only. For example, a user may provide the one or more programs with access to the location services of the user's cellular phone and the biometric data of the personal fitness tracker, only.

Based on obtaining an indication that the user is performing a credit card transaction, one or more programs in an embodiment of the present invention access the registered IoT devices of the user, based on the credentials, to obtain data related to the user that is contemporaneous with the transaction, but is not transaction data (140). Based on the contemporaneous data from the IoT devices, the one or more programs assign a level of risk to the transaction (150). The one or more programs alert the user to the level of risk (160). In some embodiments of the present invention, if the risk level exceeds a certain threshold, the one or more program may prompt the user (and/or vendor processing the transaction) regarding whether to continue with the transaction. The one or more programs may also request additional verification information from the user (or prompt the vendor to do so) to continue the transaction.

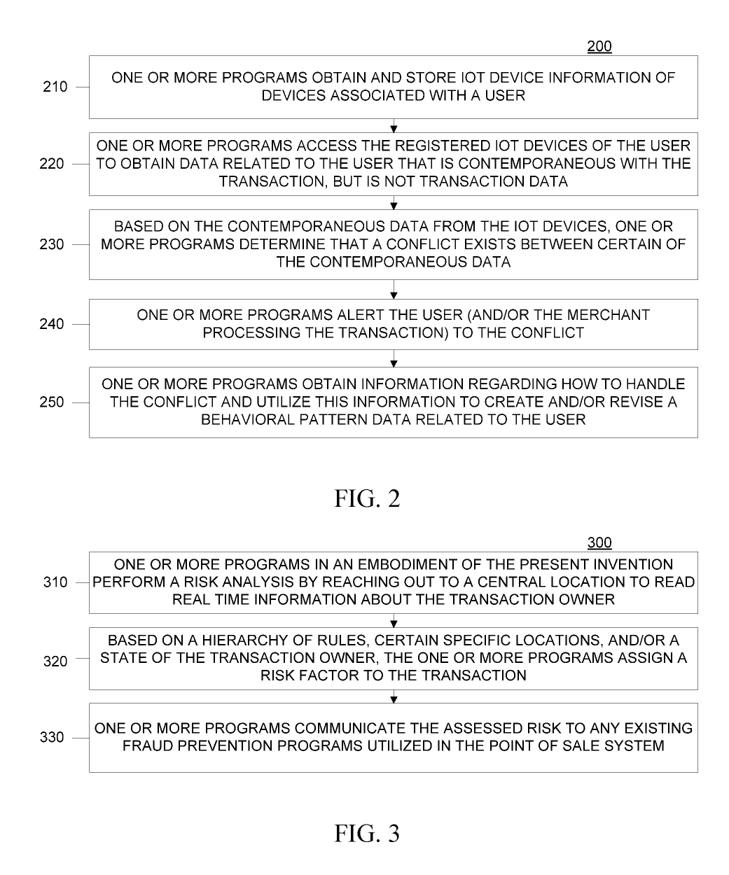

In addition to the information entered by a user, one or more programs in some embodiments of the present invention also adjudge the validity of a transactions based on behaviors and habits of a user. FIG. 2 is a workflow 200 that illustrates certain aspects of embodiments of the present invention as related to machine learning. In an embodiment of the present invention, one or more programs obtain and store IoT device information of devices associated with a user (210). Based on obtaining an indication that the user is performing a credit card transaction, one or more programs in an embodiment of the present invention access the registered IoT devices of the user to obtain data related to the user that is contemporaneous with the transaction, but is not transaction data (220).

Based on the contemporaneous data from the IoT devices, in some embodiments of the present invention, the one or more programs determine that a conflict exists between certain of the contemporaneous data (230). For example, the one or more programs may determine that a user's cellular phone is in a first location, but the user's personal fitness tracker is in a second location, and the second location is indicated in the transaction data. In this case, the location data from the cellular phone conflicts with the location data from the fitness tracker. Provided the fitness tracker location information is accurate, the transaction, which shares this location, is likely valid, but if the location information of the cellular phone reflects the location of the user, the transaction is likely fraudulent. The one or more programs alert the user (and/or the merchant processing the transaction) to the conflict (240). The one or more programs obtain information regarding how to handle the conflict and utilize this information to create and/or revise a behavioral pattern data related to the user (250). For example, if the user indicates that the transaction is valid in response to the alert, the one or more programs may determine, based on executing a machine learning algorithm, that this user's personal fitness tracker is a more reliable indicator of the location of the user than the user's cellular phone. Thus, in future transaction, if there is a location-based conflict between this user's personal fitness tracker and this user's cellular phone, the one or more programs will classify the transaction as having a low level of risk. However, if the locations are switched, the one or more programs assign a higher level of fraud risk to the transaction.

Returning to FIG. 1, the ability of the one or more programs to correctly rate the fraud risk of transactions may increase in accuracy over time based on the one or more programs monitoring activities after the one or more programs alert the user to the level of risk (160). For example, in an embodiment of the present invention, the one or more programs obtain feedback from a user (or merchant) based on alerting the user to the level of risk (170). Based on the feedback indicating a different risk level than the assigned level of risk, the one or more programs generate a business rule to apply when evaluating the risk level of a new transaction (180). For example, in a given situation, the one or more programs may adjudge a high risk level but receive feedback designating the transaction valid. The one or more programs may populate a warning requesting feedback regarding whether to continue a transaction and in response, the one or more programs may receive an indication to continue processing the transaction. Based on receiving this feedback, the one or more programs create a business rule that deems transactions with similar attributes to the adjudged transaction as having a lower risk level than previously adjudged.

In some embodiments of the present invention, based on obtaining an indication that the user is performing a credit card transaction, one or more programs in an embodiment of the present invention access the registered IoT devices of the user, based on the credentials, to obtain data related to the user that is contemporaneous with the transaction, but is not transaction data (140) and obtain any business rules relevant to the transaction data and the contemporaneous data (145). Based on the contemporaneous data from the IoT devices and any relevant business rules, the one or more programs assign a level of risk to the transaction (150). The one or more programs alert the user (and/or processor of the transaction) to the level of risk (160).

After completion of a transaction, the one or more programs may receive data related to the transaction related to the fraud risk on the transaction. For example, the one or more programs may have processed a transaction with a low risk level and received feedback indicating that the transaction was fraudulent. In an embodiment of the present invention, the one or more programs process the transaction or receive an indication that the transaction has been processed (183). In some embodiments of the present invention, the program code processes transactions, while in others, the one or more programs act as a verification layer and after alerting a user (or merchant) to a level of risk, the one or more programs pass the transaction to processing software and receive an indication when the processing is complete.

In an embodiment, the one or more programs receive data after the transaction has been processed (185). Based on the data received after the transaction, the one or more programs generate a business rule to apply when evaluating the risk level of a new transaction (180). Thus, in some embodiments of the present invention, based on obtaining an indication that the user is performing a credit card transaction, one or more programs in an embodiment of the present invention access the registered IoT devices of the user, based on the credentials, to obtain data related to the user that is contemporaneous with the transaction, but is not transaction data (140) and obtain any business rules relevant to the transaction data and the contemporaneous data (145). Based on the contemporaneous data from the IoT devices and any relevant business rules, the one or more programs assign a level of risk to the transaction (150). The one or more programs alert the user to the level of risk (160).

FIG. 3 illustrates a workflow 300 of certain embodiments of the present invention. As explained in FIG. 1, a user can register all his or her IoT devices to be accessed in a fraud determination centrally. Thus, the one or more programs can gather the information from the IoT devices at a central location for access by various point of sale programs. As seen in FIG. 3, in embodiments of the present invention, when a transaction is initiated, one or more programs in an embodiment of the present invention perform a risk analysis by reaching out to a central location to read real time information about the transaction owner (310). Based on a hierarchy of rules, certain specific locations, and/or a state of the transaction owner, the one or more programs assign a risk factor to the transaction (320). In and embodiment of the present invention, the one or more programs communicate the assessed risk to any existing fraud prevention programs utilized in the point of sale system (330). As understood by one of skill in the art, a negative analysis has a higher chance of being correct than a positive transaction has of ensuring a safe request.

When certain embodiments of the present invention are integrated with a point of sale or other transaction system, the one or more program do not stop transactions based on assessed risk, but, rather, help identify the risk associated with the transactions. Based on this information, a service provider can then request additional verification, much the way a credit card company may request that a card holder call to validate a transaction that is registered in another country or over a certain dollar amount. This validation could be human intervention or the request for additional passwords, biometric scans, or other additional identifying information.

Embodiments of the present invention include a computer-implemented method, a computer program product, and a computer system where one or more programs, executed by at least one processing circuit, receive into a data repository, over a communications connection, user identification data, identification data related to one or more personal computing devices, and credential information for accessing data collected by the one or more personal computing devices. The one or more programs obtain an indication that another one or more programs are initiating a transaction, where transaction data of the transaction indicates that the transaction was initiated on behalf of the user. The one or more programs utilize the credential information to access data related to the user collected by the one or more personal computing devices, wherein the data related to the user was collected by the one or more personal computing devices contemporaneously with the initiating the transaction. The one or more programs determine a risk of fraud associated with the transaction, based on a portion of the data related to the user, where the risk of fraud indicates a likelihood that the transaction is fraudulent. The one or more programs alert the other one or more programs initiating the transaction of the risk of fraud.

In some embodiments of the present invention, responsive to the alerting, the one or more programs receive data negating the determined risk of fraud. The one or more programs generate a business rule to assign, where based on applying the business rule the one or more processors determine a different risk of fraud for a future transaction, where data related to the user contemporaneous with the future transaction comprise data similar to the portion of the data related to the user, where the different level of fraud indicates a higher risk or a lower risk of fraud than the determined risk of fraud associated with the transaction.

In some embodiments of the present, the one or more programs also obtain an indication that one or more programs are initiating another transaction, where transaction data of the other transaction indicates that the other transaction was initiated on behalf of the user. The one or more programs utilize the credential information to access additional data related to the user collected by the one or more personal computing devices, where the additional data related to the user was collected by the one or more personal computing devices contemporaneously with the initiating the other transaction. The one or more programs determine that the additional data related to the user comprise data similar to the portion of the data related to the user. The one or more programs determine a risk of fraud associated with the other transaction, based on a portion of the additional data related to the user and the business rule, where the risk of fraud indicates a likelihood that the other transaction is fraudulent. The one or more programs alert the one or more programs initiating the other transaction of the risk of fraud associated with the other transaction.

In some embodiments of the present transaction, the risk of fraud is unknown based on conflicting information comprising the portion of the data. The one or more programs alert with a request for verification. The one or more programs may also, responsive to the alerting, obtain data resolving the conflicting information. The one or more programs determine a corrected risk of fraud, based on the data resolving the conflicting information. The one or more programs alert the other one or more programs, which are initiating the other transaction of the corrected risk of fraud.

In some embodiments of the present invention the one or more programs also generate a business rule to assign, where based on applying the business rule the one or more processors determine a risk of fraud for a future transaction, where data related to the user contemporaneous with the future transaction comprise the conflicting information. Thus, in an aspects of one or these embodiments the one or more programs may obtain an indication that one or more programs are initiating another transaction, where transaction data of the other transaction indicates that the other transaction was initiated on behalf of the user. The one or more programs utilize the credential information to access additional data related to the user collected by the one or more personal computing devices, where the additional data related to the user was collected by the one or more personal computing devices contemporaneously with the initiating the other transaction;. The one or more programs determine that the additional data related to the user comprises the conflicting information. The one or more programs determine a risk of fraud associated with the other transaction, based on a portion of the additional data related to the user and the business rule, wherein the risk of fraud indicates a likelihood that the other transaction is fraudulent. The one or more programs alert the one or more programs initiating the other transaction of the risk of fraud associated with the other transaction.

In some embodiments of the present invention, the data related to the user is selected from the group consisting of: a location of the user, a location type of the location of the user, the state of the user, and biometric data of the user. In other embodiments of the present invention, the data related to the user indicates that the user is engaged in an activity where concurrently engaging in the transaction is not likely, and the determined risk of fraud is high. In other embodiments of the present invention, the data related to the user indicates that the user is at a location type where concurrently engaging in the transaction is not likely, and the determined risk of fraud is high.

In some embodiments of the present invention, the one or more programs also based on the risk of fraud indicating a high likelihood of fraud, transmit an instruction to halt the transaction, to the one or more programs initiating the transaction. The one or more programs processing the transaction may be part of a point of sale application.

Referring now to FIG. 4, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, an IoT device 100 can be understood as cloud computing node 10 (FIG. 4) and if not a cloud computing node 10, then one or more general computing node that includes aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

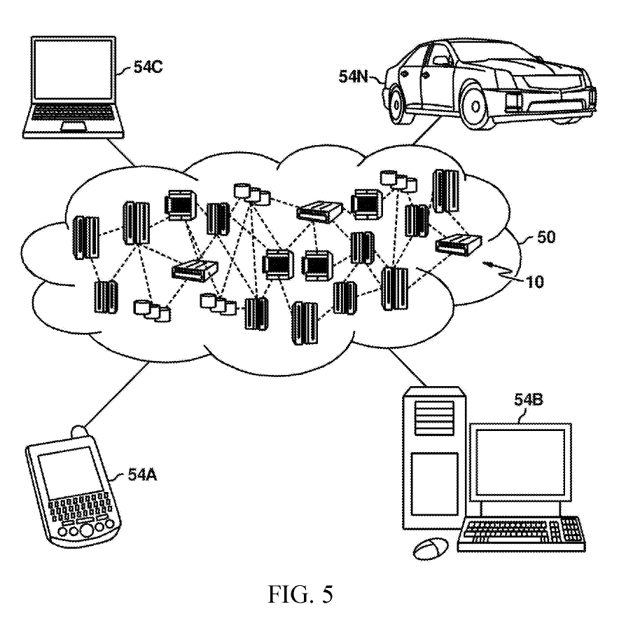

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

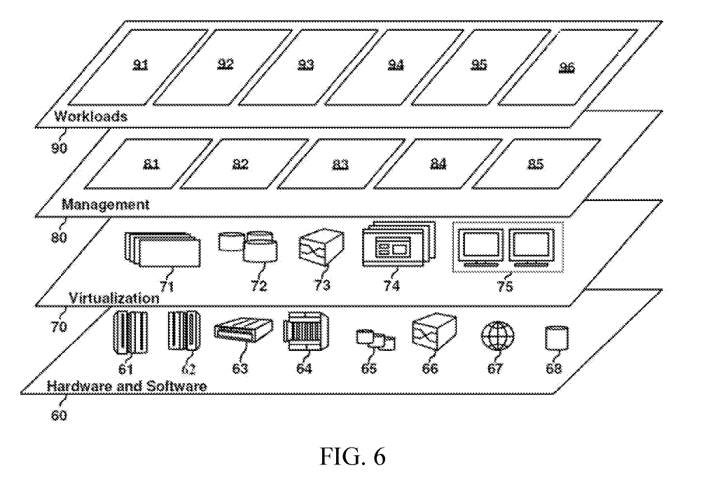

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and adjudging the risk of fraud associated with a transaction 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RANI), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
receiving, by one or more processors, into a data repository, over a communications connection, user identification data, identification data related to one or more personal computing devices, and credential information for accessing data collected by the one or more personal computing devices;
obtaining, by the one or more processors, an indication that one or more programs are initiating a transaction, wherein transaction data of the transaction indicates that the transaction was initiated on behalf of the user;
utilizing, by the one or more processors, the credential information to access data related to the user collected by the one or more personal computing devices, wherein the data related to the user was collected by the one or more personal computing devices contemporaneously with the initiating the transaction;
determining, by the one or more processors, a risk of fraud associated with the transaction, based on a portion of the data related to the user, wherein the risk of fraud indicates a likelihood that the transaction is fraudulent; and
alerting, by the one or more processors, the one or more programs initiating the transaction of the risk of fraud.

2. The computer-implemented method of claim 1, further comprising:
responsive to the alerting, receiving, by the one or more processors, data negating the determined risk of fraud; and
generating, by the one or more processors, a business rule to assign, wherein based on applying the business rule the one or more processors determine a different risk of fraud for a future transaction, wherein data related to the user contemporaneous with the future transaction comprise data similar to the portion of the data related to the user, wherein the different level of fraud indicates a higher risk or a lower risk of fraud than the determined risk of fraud associated with the transaction.

3. The computer-implemented method of claim 2, further comprising:
obtaining, by the one or more processors, an indication that one or more programs are initiating another transaction, wherein transaction data of the other transaction indicates that the other transaction was initiated on behalf of the user;
utilizing, by the one or more processors, the credential information to access additional data related to the user collected by the one or more personal computing devices, wherein the additional data related to the user was collected by the one or more personal computing devices contemporaneously with the initiating the other transaction;
determining, by the one or more processors, that the additional data related to the user comprise data similar to the portion of the data related to the user;
determining, by the one or more processors, a risk of fraud associated with the other transaction, based on a portion of the additional data related to the user and the business rule, wherein the risk of fraud indicates a likelihood that the other transaction is fraudulent; and
alerting, by the one or more processors, the one or more programs initiating the other transaction of the risk of fraud associated with the other transaction.

4. The computer-implemented method of claim 1, wherein the risk of fraud is unknown based on conflicting information comprising the portion of the data, and wherein the alerting comprises a request for verification, the method further comprising:
responsive to the alerting, obtaining, by the one or more processors, data resolving the conflicting information;
determining, by the one or more processors, a corrected risk of fraud, based on the data resolving the conflicting information;
alerting, by the one or more processors, the one or more programs initiating the other transaction of the corrected risk of fraud.

5. The computer-implemented method of claim 4, further comprising:
generating, by the one or more processors, a business rule to assign, wherein based on applying the business rule the one or more processors determine a risk of fraud for a future transaction, wherein data related to the user contemporaneous with the future transaction comprise the conflicting information.

6. The computer-implemented method of claim 5, further comprising:
obtaining, by the one or more processors, an indication that one or more programs are initiating another transaction, wherein transaction data of the other transaction indicates that the other transaction was initiated on behalf of the user;
utilizing, by the one or more processors, the credential information to access additional data related to the user collected by the one or more personal computing devices, wherein the additional data related to the user was collected by the one or more personal computing devices contemporaneously with the initiating the other transaction;
determining, by the one or more processors, that the additional data related to the user comprises the conflicting information;
determining, by the one or more processors, a risk of fraud associated with the other transaction, based on a portion of the additional data related to the user and the business rule, wherein the risk of fraud indicates a likelihood that the other transaction is fraudulent; and
alerting, by the one or more processors, the one or more programs initiating the other transaction of the risk of fraud associated with the other transaction.

7. The computer-implemented method of claim 1, wherein the data related to the user is selected from the group consisting of: a location of the user, a location type of the location of the user, the state of the user, and biometric data of the user.

8. The computer-implemented method of claim 1, wherein the data related to the user indicates that the user is engaged in an activity where concurrently engaging in the transaction is not likely, and wherein the determined risk of fraud is high.

9. The computer-implemented method of claim 1, wherein the data related to the user indicates that the user is at a location type where concurrently engaging in the transaction is not likely, and wherein the determined risk of fraud is high.

10. The computer-implemented method of claim 1, further comprising:
based on the risk of fraud indicating a high likelihood of fraud, transmitting, by the one or more processors, an instruction to halt the transaction, to the one or more programs initiating the transaction.

11. The computer-implemented method of claim 10, wherein the one or more programs comprise one or more programs in a point of sale application.

12. A computer program product comprising:
a computer readable storage medium readable by one or more processors and storing instructions for execution by the one or more processors for performing a method comprising:
receiving, by the one or more processors, into a data repository, over a communications connection, user identification data, identification data related to one or more personal computing devices, and credential information for accessing data collected by the one or more personal computing devices;
obtaining, by the one or more processors, an indication that one or more programs are initiating a transaction, wherein transaction data of the transaction indicates that the transaction was initiated on behalf of the user;
utilizing, by the one or more processors, the credential information to access data related to the user collected by the one or more personal computing devices, wherein the data related to the user was collected by the one or more personal computing devices contemporaneously with the initiating the transaction;
determining, by the one or more processors, a risk of fraud associated with the transaction, based on a portion of the data related to the user, wherein the risk of fraud indicates a likelihood that the transaction is fraudulent; and
alerting, by the one or more processors, the one or more programs initiating the transaction of the risk of fraud.

13. The computer program product of claim 12, the method further comprising:
responsive to the alerting, receiving, by the one or more processors, data negating the determined risk of fraud; and
generating, by the one or more processors, a business rule to assign, wherein based on applying the business rule the one or more processors determine a different risk of fraud for a future transaction, wherein data related to the user contemporaneous with the future transaction comprise data similar to the portion of the data related to the user, wherein the different level of fraud indicates a higher risk or a lower risk of fraud than the determined risk of fraud associated with the transaction.

14. The computer program product of claim 13, the method further comprising:
obtaining, by the one or more processors, an indication that one or more programs are initiating another transaction, wherein transaction data of the other transaction indicates that the other transaction was initiated on behalf of the user;
utilizing, by the one or more processors, the credential information to access additional data related to the user collected by the one or more personal computing devices, wherein the additional data related to the user was collected by the one or more personal computing devices contemporaneously with the initiating the other transaction;
determining, by the one or more processors, that the additional data related to the user comprise data similar to the portion of the data related to the user;
determining, by the one or more processors, a risk of fraud associated with the other transaction, based on a portion of the additional data related to the user and the business rule, wherein the risk of fraud indicates a likelihood that the other transaction is fraudulent; and
alerting, by the one or more processors, the one or more programs initiating the other transaction of the risk of fraud associated with the other transaction.

15. The computer program product of claim 12, wherein the risk of fraud is unknown based on conflicting information comprising the portion of the data, and wherein the alerting comprises a request for verification, the method further comprising:
responsive to the alerting, obtaining, by the one or more processors, data resolving the conflicting information;
determining, by the one or more processors, a corrected risk of fraud, based on the data resolving the conflicting information;
alerting, by the one or more processors, the one or more programs initiating the other transaction of the corrected risk of fraud.

16. The computer program product of claim 15, the method further comprising:
generating, by the one or more processors, a business rule to assign, wherein based on applying the business rule the one or more processors determine a risk of fraud for a future transaction, wherein data related to the user contemporaneous with the future transaction comprise the conflicting information.

17. The computer program product of claim 16, the method further comprising:
obtaining, by the one or more processors, an indication that one or more programs are initiating another transaction, wherein transaction data of the other transaction indicates that the other transaction was initiated on behalf of the user;
utilizing, by the one or more processors, the credential information to access additional data related to the user collected by the one or more personal computing devices, wherein the additional data related to the user was collected by the one or more personal computing devices contemporaneously with the initiating the other transaction;
determining, by the one or more processors, that the additional data related to the user comprises the conflicting information;
determining, by the one or more processors, a risk of fraud associated with the other transaction, based on a portion of the additional data related to the user and the business rule, wherein the risk of fraud indicates a likelihood that the other transaction is fraudulent; and
alerting, by the one or more processors, the one or more programs initiating the other transaction of the risk of fraud associated with the other transaction.

18. The computer program product of claim 12, wherein the data related to the user is selected from the group consisting of: a location of the user, a location type of the location of the user, the state of the user, and biometric data of the user.

19. The computer program product of claim 12, wherein the data related to the user indicates that the user is engaged in an activity where concurrently engaging in the transaction is not likely, and wherein the determined risk of fraud is high.

20. A system comprising:
a memory;
one or more processors in communication with the memory; and
program instructions executable by the one or more processors via the memory to perform a method, the method comprising:
receiving, by the one or more processors, into a data repository, over a communications connection, user identification data, identification data related to one or more personal computing devices, and credential information for accessing data collected by the one or more personal computing devices;
obtaining, by the one or more processors, an indication that one or more programs are initiating a transaction, wherein transaction data of the transaction indicates that the transaction was initiated on behalf of the user;
utilizing, by the one or more processors, the credential information to access data related to the user collected by the one or more personal computing devices, wherein the data related to the user was collected by the one or more personal computing devices contemporaneously with the initiating the transaction;
determining, by the one or more processors, a risk of fraud associated with the transaction, based on a portion of the data related to the user, wherein the risk of fraud indicates a likelihood that the transaction is fraudulent; and
alerting, by the one or more processors, the one or more programs initiating the transaction of the risk of fraud.
